(19) United States
(12) Patent Application Publication
(10) Pub. No.: US 2004/0020607 A1
(43) Pub. Date: Feb. 5, 2004

(54) Overhead door shade system

(76) Inventors: Juan Aguirre JR., Scottsdale, AZ (US); Raymond L. Miller JR., Chandler, AZ (US); Steven C. Salatino, Phoenix, AZ (US)

Correspondence Address: STONEMAN LAW OFFICES, LTD, 3113 NORTH 3RD STREET, PHOENIX, AZ, 85012, US

(21) Appl. No.: 10/613,970

(22) Filed: Jul. 3, 2003

Related U.S. Application Data
(60) Provisional application No. 60/393,993, filed on Jul. 3, 2002.

(51) Int. Cl. E06B 3/48

(52) U.S. Cl. 160/113

(57) ABSTRACT

A system for improved shading of the interior of a building, more specifically, a shade system for use within a door opening of the building where the door opening is serviced by at least one overhead access door, such as a vehicular garage door or rolling service door. The system comprises a flexible fabric shade panel having apertures through the fabric for user access and wind relief. The system may be permanently mounted to an interior portion of the door. The shade panel is raised, lowered and stowed using a spring-assisted rolling storage assembly. The installed system does not interfere with the normal operation of the overhead door.

### CROSS-REFERENCE TO RELATED APPLICATIONS

The present application is related to applicant's prior U.S. Provisional Application No. 60/393,993, filed Jul. 3, 2002, entitled “Overhead Door Shade System”, the contents of which are hereby herein incorporated by reference and are not admitted to be prior art with respect to the present invention by their mention in this cross-reference section.

### BACKGROUND

This invention relates to providing a system for improved shading of the interior of a building. More specifically, this invention relates to a shade system for use within a door opening of a building where the door opening comprises at least one overhead access door, such as a vehicular garage door or rolling service door.

Frequently, residential and commercial building designs include the provision for one or more vehicular access doors. Well-known examples of vehicular access doors include residential overhead garage doors for private motor vehicles, and rolling service doors used in the shipping and receiving operations of commercial warehouses. A common characteristic of most vehicular access doors is that of relatively large size. A minimum opening width for a single car access door is about eight feet, while multiple vehicular openings may range in width from slightly less than twenty feet, to well over fifty feet. Often, the solar orientations of these relatively large openings are not ideal, allowing an undesirable amount of sunlight to enter the interior of the building. In many instances, due to operational requirements or convenience, it is highly desirable for the overhead door to remain in an open position for a protracted period.

It has been demonstrated that each unprotected square foot of sunlit interior surface can generate up to 230 BTUs of heat. Interior spaces without the benefit of solar control can quickly become intolerably uncomfortable for the occupants of the space due to solar heat gain and glare. Frequently, the interior space of a building served by a vehicular door is occupied by one or more persons for extended periods. For example, residential garages often serve as workshop or hobby spaces, and commercial loading docks are often staffed continuously during daylight hours. Energy costs to comfortably condition a space without solar control is consistently higher than similar spaces equipped with solar control systems. Many materials are susceptible to damage by prolonged exposure to sunlight (e.g., damage often referred to as “sun-rot”). Additionally, an increasing number of public health organizations have expressed concerns about prolonged human exposure to the ultra violet rays contained in sunlight. It is clear that a need exists for an improved system for controlling the entry of sunlight through large overhead doors. A system of shading that is quickly deployed by the occupant/user of the system, which system does not hinder the operation of the overhead door, would be of benefit to many.

### OBJECTS OF THE INVENTION

A primary object and feature of the present invention is to provide a system for shading the interior of a building from sunlight passing through an open overhead access door.

It is a further object and feature of the present invention to provide such a system that is mounted to the overhead access door, allowing for full functionality of the door without removal of the system.

It is an additional object and feature of the present invention to provide such a system that is compactly storable while remaining mounted to the door.

It is an additional object and feature of the present invention to provide such a system allowing convenient user passage through the system while the system is in use.

A further primary object and feature of the present invention is to provide such a system that is efficient, inexpensive and handy. Other objects and features of this invention will become apparent with reference to the following descriptions.

### SUMMARY OF THE INVENTION

In accordance with a preferred embodiment hereof, this invention provides a shading system for shading at least one interior portion of a building from sunlight entering through at least one building opening serving at least one overhead-type access door, comprising in combination at least one blocker structured and arranged to block sunlight passing through at least one portion of the at least one building opening; at least one attacher structured and arranged to firmly attach such at least one blocker to at least one interior portion of the at least one overhead-type access door; and at least one stower structured and arranged to stow at least one portion of such at least one blocker on the interior portion of the at least one overhead-type access door when such at least one blocker is not in full use.

Additionally, it provides such a system wherein such at least one blocker comprises: at least one flexible fabric; wherein such at least one flexible fabric is structured and arranged to pass a controlled quantity of sunlight. Further, it provides such a system wherein such at least one blocker comprises: at least one tensioner structured and arranged to tension such at least one flexible fabric. Moreover, it provides such a system wherein such at least one tensioner comprises: at least one horizontal bottom bar. Additionally, it provides such a system wherein such at least one stower comprises at least one securer structured and arranged to removably secure at least one portion of such at least one blocker to at least one interior portion of the at least one overhead-type access door. Further, it provides such a system wherein such at least one securer comprises: at least one elastic cord having at least one hook.

Furthermore, it provides such a system wherein such at least one stower comprises: at least one rolling lifter structured and arranged to lift such at least one blocker from an unrolled position to a rolled position; and at least one retainer structured and arranged to retain such at least one blocker in at least one rolled position, at least one unrolled position and at least one intermediate rolled position. Additionally, it provides such a system wherein such at least one rolling lifter comprises: at least one rolling support tube; and at least one spring tensioner; wherein such at least one spring tensioner is structured and arranged to generate a winding force within such at least one roller tube as such at least one blocker is lowered to the unrolled position.

Moreover, it provides such a system wherein such at least one attacher comprises at least one support bracket mechanically fastened to the at least one overhead-type access door. Additionally, it provides such a system wherein such at least one blocker comprises at least one movement resister structured and arranged to resist movement of at least one portion of such at least one blocker when such at least one blocker is in an unstowed position. In addition, it provides such a system wherein such at least one movement resister comprises: at least one friction retainer structured and arranged to retain such at least one blocker in an essentially fixed position.

Additionally, it provides such a system wherein such at least one movement resister comprises at least one hook-and-loop retainer structured and arranged to retain such at least one blocker in an essentially fixed position. Further, it provides such a system wherein such at least one movement resister comprises at least magnetic retainer structured and arranged to magnetically retain such at least one blocker in an essentially fixed position. Even further, it provides such a system wherein such at least one blocker comprises at least one wind load reliever structured and arranged to relieve a wind load force acting on at least one surface portion of such at least one blocker. Additionally, it provides such a system wherein such at least one blocker comprises: at least one opener structured and arranged to open at least one access portal through such at least one blocker; and at least one access blocker structured and arranged to block access through such at least one access portal. Additionally, it provides such a system wherein such at least one access blocker comprises at least one zipper. Moreover, it provides such a system wherein such at least one access blocker comprises: at least one hook-and-loop fastener.

Additionally, in accordance with a preferred embodiment hereof, this invention provides a shading system for shading at least one interior portion of a building from sunlight entering through at least one building opening serving at least one overhead-type access door, comprising in combination at least one overhead-type access door; at least one blocker structured and arranged to block sunlight passing through at least one portion of the at least one building opening; at least one attacher structured and arranged to firmly attach such at least one blocker to at least one interior portion of such at least one overhead-type access door; and at least one stower structured and arranged to stow at least one portion of such at least one blocker on the interior portion of such at least one overhead-type access door when such at least one blocker is not in full use.

Additionally, it provides such a system wherein such at least one attacher comprises at least one support bracket mechanically fastened to the at least one overhead-type access door. Furthermore, it provides a system wherein such at least one attacher comprises at least one support bracket integrally formed with such at least one overhead-type access door.

### BRIEF DESCRIPTION OF THE DRAWINGS

FIG. 1 is a perspective view of the overhead door shade system mounted to an overhead door, shown shading the interior of a building structure according to a preferred embodiment of the present invention.

FIG. 2 is an interior elevational view of the overhead door shade system of FIG. 1.

FIG. 3 is a section view through the section 3-3 of FIG. 1.

FIG. 4 is a perspective view, partially in section, of Detail 4 of FIG. 2.

FIG. 5 is a view through the section 5-5 of FIG. 4.

FIG. 6 is a view through the section 6-6 of FIG. 4

FIG. 7 is a perspective view, partially in section, of a preferred bottom retainer of the overhead door shade system.

FIG. 8 is a perspective view, partially in section, of another preferred bottom retainer of the overhead door shade system.

FIG. 9 is a perspective view, partially in section, of yet another bottom retainer of the overhead door shade system.

FIG. 10 is a perspective view, partially in section, of an alternate preferred embodiment of the overhead door shade system shown fully extended and mounted to an overhead door.

FIG. 11 is a perspective view, partially in section, of the overhead door shade system of FIG. 10 shown mounted to an overhead door, in a stored position.

FIG. 12 is a perspective view of the overhead door shade system shown mounted to a rolling overhead door, illustrating an alternate preferred installation according to another preferred embodiment of the present invention.

### DETAILED DESCRIPTION OF A PREFERRED EMBODIMENT OF THE INVENTION

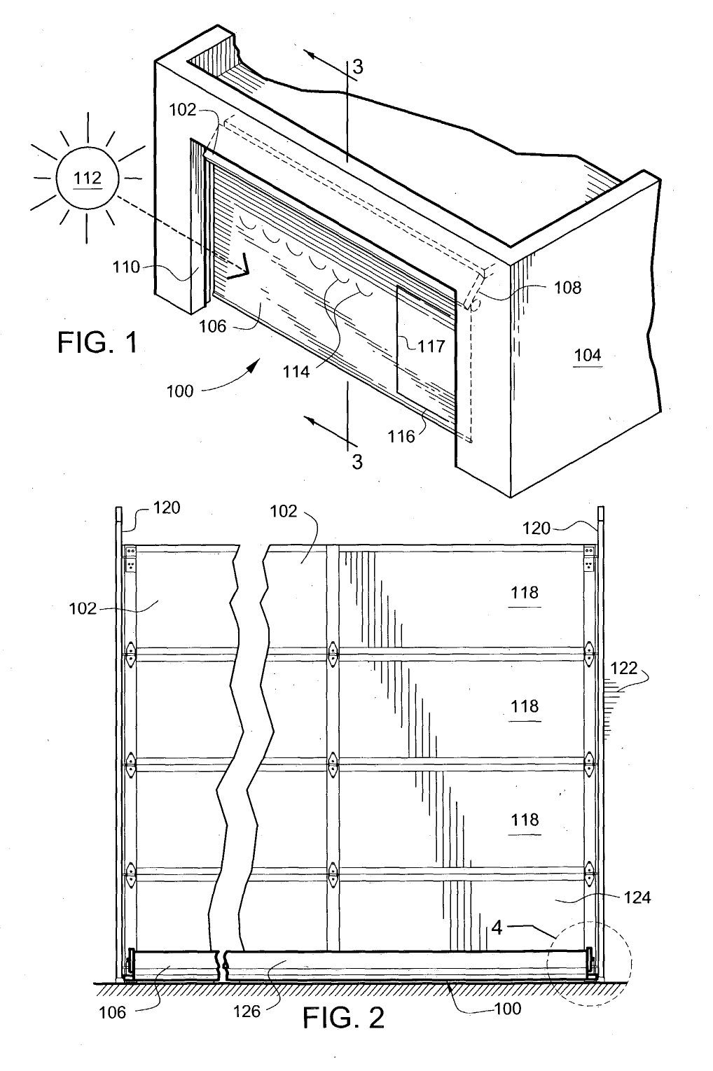

FIG. 1 is a perspective view of an overhead door shade system 100 mounted to an open overhead door 102, shown shading the interior of a building structure 104 from sunlight 112 entering through a door opening 110, according to a preferred embodiment of the present invention. Preferably, overhead door shade system 100 comprises a flexible screen panel 106 (embodying herein at least one blocker structured and arranged to block sunlight passing through at least one portion of the at least one building opening) that is mounted to the lower interior face 108 of overhead door 102, as shown. When overhead door 102 is in an open position, overhead door shade system 100 may preferably be lowered to protect all or part of door opening 110, as shown. It should be noted that “open”, in reference to the present invention, included all positions of a door between a closed position and a fully opened position. Overhead door shade system 100 preferably includes semi-circular, wind-relieving slits 114 (embodying herein at least one wind load reliever structured and arranged to relieve a wind load force acting on at least one surface portion of such at least one blocker) and a passage door 116, as shown. The preferred passage door 116 (embodying herein at least one opener structured and arranged to open at least one access portal through such at least one blocker; and at least one access blocker structured and arranged to block access through such at least one access portal) provides convenient access through screen panel 106 of overhead door shade system 100 without raising or storing the system, as shown. Preferably, passage door 116 comprises an essentially rectangular “C”-shaped slit having a continuous zipper 117 sewn to the perimeter edge, as shown. Upon reading the teachings of this specification, those with ordinary skill in the art will now understand that, under appropriate circumstances, consider such issues as intended use, non-wind locations, manufacturing and design efficiency, marketability studies, etc., other sealing methods to retain the passage door, such as hook-and-loop fasteners, gravity, ties, etc., may suffice. Also, upon reading the teachings of this specification, those with ordinary skill in the art will now understand that, under appropriate circumstances, consider such issues as intended use, user preference, manufacturing and design efficiency, marketability studies, etc., other passage door shapes, such as oval, curved, etc., may suffice. FIG. 2 is an interior elevational view of the overhead door shade system 100 of FIG. 1 mounted to a closed overhead door 102. FIG. 2 shows the interior face of overhead door 102 (as viewed from the building interior). In the preferred embodiment shown in FIG. 2, the configuration of overhead door 102 is typical of a type of residential garage door having a series of essentially rectangular-hinged panels 118 that are retained by end track(s) 120, as shown. The overhead door 102 is preferably designed such that the end track(s) 120 are permanently mounted to an interior wall 122 of the building structure 104, as shown. Hinged panels 118 forming overhead door 102 are preferably free to move up and down within the fixed end track(s) 120 when overhead door 102 is opened and closed. Preferably, overhead door shade system 100 is mounted to the lower portion of bottom panel 124, as shown. Preferably, no portion of overhead door shade system 100 is mounted between a fixed and an operable portion of the overhead door 102, allowing the door to remain operational while overhead door shade system 100 is attached. Therefore, overhead door shade system 100 may preferably be installed on overhead door 102 in a permanent manner, as shown. Preferably, overhead door shade system 100 provides a manually operated roll-up lifting feature that allows the screen panel 106 to be rolled-up and retained in a compact stored roll 126 when not in use, as shown. Those with ordinary skill in the art, upon reading the teachings of this specification, will now appreciate that, under appropriate circumstances, considering issues such as economic considerations, user preferences, etc., other methods of operating the overhead door shade system 100, such as automatic, timed, wireless operation etc., may suffice.

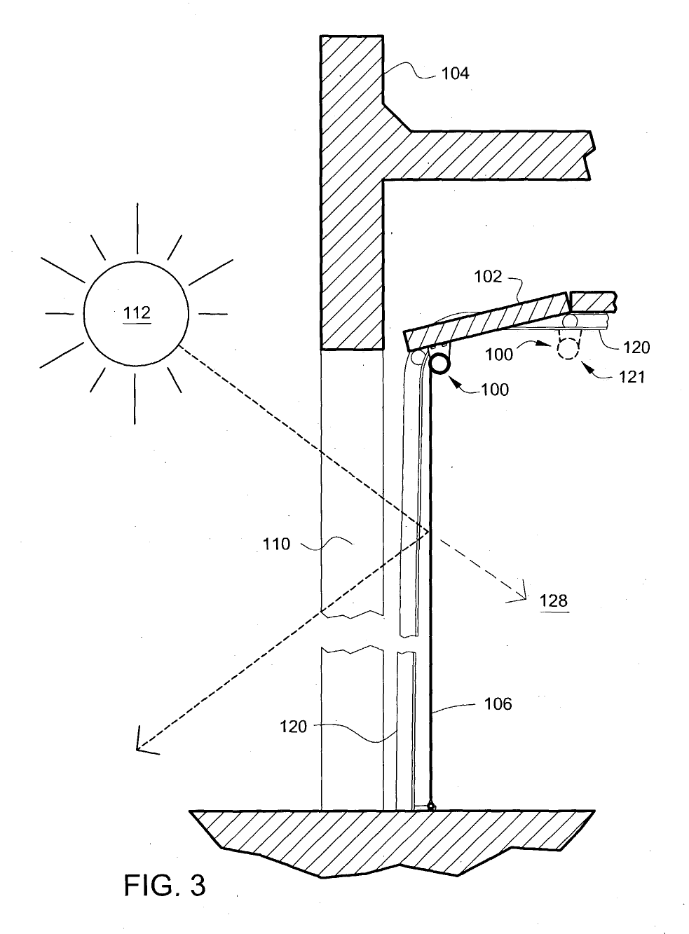

FIG. 3 is a view through the section 3-3 of FIG. 1, showing overhead door shade system 100 mounted to overhead door 102. Adjusting overhead door 102 to any open position allows overhead door shade system 100 to be extended to provide shade protection to building interior 128 of building structure 104, as shown. FIG. 3 illustrates overhead door 102 in a fully open position with the screen panel 106 unrolled to a fully lowered position. Preferably, screen panel 106 is essentially rectangular, having a preferred maximum width equaling the width of overhead door 102, and a maximum height preferably matching the height of door opening 110. Upon reading the teachings of this specification, those with ordinary skill in the art will now understand that, under appropriate circumstances, considering such issues as accommodating specific mounting applications, etc., other shapes and sizes of the screen panel may suffice.

Preferably, screen panel 106 is formed from a single fabric panel. Upon reading the teachings of this specification, those with ordinary skill in the art will now understand that, under appropriate circumstances such as to accommodate especially wide door openings, create areas of varying shade density or to provide a variety of colors, etc., other screen panel configurations such as two or more fabric panels joined edge-to-edge, etc., may suffice. Screen panel 106 preferably comprises a UV-resistant vinyl-covered polyester material, such as “Suntex”™ shade fabric (as produced by Phifer Wire Products, Inc. of Tuscaloosa, Ala., USA). Preferably, the fabric of screen panel 106 may be selected from a group of fabrics having a range of shade factors (defined as the amount of open light admitting area versus the closed or opaque area of the fabric) matching the shading requirements of a specific installation (embodying herein at least one flexible fabric; wherein such at least one flexible fabric is structured and arranged to pass a controlled quantity of sunlight). Typical screen panel materials may pass 10% to 50% of the sunlight falling on the fabric surface. Upon reading the teachings of this-specification, those with ordinary skill in the art will now understand that, under appropriate circumstances, considering such issues as intended use, outward visibility requirements, privacy requirements, air-flow, etc., other shading materials providing sunlight filtering, reduced glare, better outward visibility, daytime privacy and passage of air, etc., may suffice. Other preferable shade screen materials include knitted polyethylene and PVC-coated fiberglass fabrics. Preferably, the edges of screen panel 106 are finished in a matching bias tape. Upon reading the teachings of this specification, those with ordinary skill in the art will now understand that, under appropriate circumstances, considering such issues as user preference, marketability studies, manufacturing and design requirements, etc., other finishes for the edge of screen panel 106, such as an unfinished edge or an edge finished with a folded and sewn “hemmed edge,” etc., may suffice.

It should be noted that overhead door shade system 100 may, under appropriate circumstances, be mounted in a number of positions on overhead door 102. For example, overhead door shade system 100 may be mounted to end tracks 120 in-alternate position 121, as shown.

FIG. 4 is a perspective view, partially in section, of Detail 4 of FIG. 2. FIG. 4 shows the overhead door shade system 100 mounted to overhead door 102. Overhead door shade system 100 is preferably mounted to overhead door 102 using end support bracket 130 (embodying herein at least one attacher structured and arranged to firmly attach such at least one blocker to at least one interior portion of the at least one overhead-type access door and embodying herein at least one support bracket mechanically fastened to the at least one overhead-type access door), as shown. Preferably, end support bracket 130 is formed from a rigid material, preferably metal, most preferably steel. Upon reading the teachings of this specification, those with ordinary skill in the art will now understand that, under appropriate circumstances, considering such issues as economy, weight, manufacturing and design requirements, etc., other end support bracket materials, such as durable plastic, etc., may suffice. Preferably, end support bracket 130 is mechanically fastened to at least one interior panel-reinforcing member 132 of overhead door 102 using semi-permanent fasteners 136, such as self-tapping screws, bolts or similar fasteners, as shown. Upon reading the teachings of this specification, those with ordinary skill in the art will now understand that, under appropriate circumstances, end support bracket 130 may be riveted, welded, or integral to, overhead door 102 (embodying herein at least one support bracket integrally formed with such at least one overhead-type access door), as would be supplied with a factory-installed system.

Preferably, end support bracket 130 is used at each end of overhead door shade system 100. Preferably, end support bracket 130 is designed to removably retain idler assembly 134, part of the preferred roller lifting system 140 (embodying herein at least one stower structured and arranged to stow at least one portion of such at least one blocker on the interior portion of the at least one overhead-type access door when such at least one blocker is not in full use, and embodying herein at least one rolling lifter structured and arranged to lift such at least one blocker from at least one unrolled position to at least one rolled position) that uses the principle of the capstan to wind up and retain screen panel 106, as shown. Preferably, roller lifting system 140 is similar in operation to roller-shades of typical types and is preferably capable of lifting and supporting the entire weight of screen panel 106. Roller lifting system 140 preferably comprises idler assembly 134, preferably located at the ends of roller tube 138 (embodying herein at least one rolling support tube) to provide a rotary bearing and support function for the rotating components of overhead door shade system 100, as shown. The upper edge of screen panel 106 is preferably supported by roller tube 138 by attachment along its length. Additionally, roller lifting system 140 preferably comprises at least one roller spring 142 (embodying herein at least one spring tensioner), preferably in the form of a long, closely wound extension spring, used to generate a counter torsional force applied to roller tube 138 as screen panel 106 is unwound (embodying herein wherein such at least one spring tensioner is structured and arranged to generate a winding force within such at least one roller tube as such at least one blocker is lowered to the unrolled position).

Further, roller lifting system 140 preferably comprises at least one clutch system (internal to idler assembly 134) commonly comprising a series of one-way spring clutches that allow roller tube 138 to rotate when the user applies force and that prevent rotation when the force is removed (herein embodying at least one retainer structured and arranged to retain such at least one blocker in the at least one rolled position, the at least one unrolled position and at least one intermediate rolled position). Preferably, the diameter and construction of roller tube 138 allows the assembly to be self-supporting, spanning between end support bracket(s) 130 with essentially no deflection. Upon reading the teachings of this specification, those with ordinary skill in the art will now understand that, under appropriate circumstances, considering such issues as user preference, marketability studies, improvements in shade technology, design and manufacturing requirements, etc., other methods of raising and lowering the shade panel, such as chain operation, hand-rolling, etc., may suffice.

A hembar 144 is preferably used at the bottom edge of screen panel 106 to keep the fabric straight and taut, as shown. Hembar 144 (embodying herein at least one tensioner structured and arranged to tension such at least one flexible fabric, wherein such at least one tensioner comprises at least one horizontal bottom bar) is preferably of a hollow design, but under appropriate circumstances, may be, for example, solid to provide additional weight for added stability. Preferably, hembar 144 is constructed from a rigid PVC plastic having an inner diameter of about ½″. Upon reading the teachings of this specification, those with ordinary skill in the art will now understand that, under appropriate circumstances, considering such issues as weight, durability, cost, etc., other essentially rigid materials, such as metal, wood, etc., may suffice. Preferably, hembar 144 is attached to screen panel 106 by insertion into a continuous pocket within the screen panel 106. Upon reading the teachings of this specification, those with ordinary skill in the art will now understand that, under appropriate circumstances, considering such issues as user preferences, design and manufacturing requirements, etc., other hembar to shade panel fastening methods, such as adhesive attachment, mechanical fastening, etc., may suffice. Also, upon reading the teachings of this specification, those with ordinary skill in the art will now understand that, under appropriate circumstances, considering such issues as user preferences, marketability studies, etc., other sizes, styles and shapes of hembar, such as extending the ends of hembar 144 beyond the width of screen panel 106 to engage bottom retainer 146 (as shown), etc., may suffice.

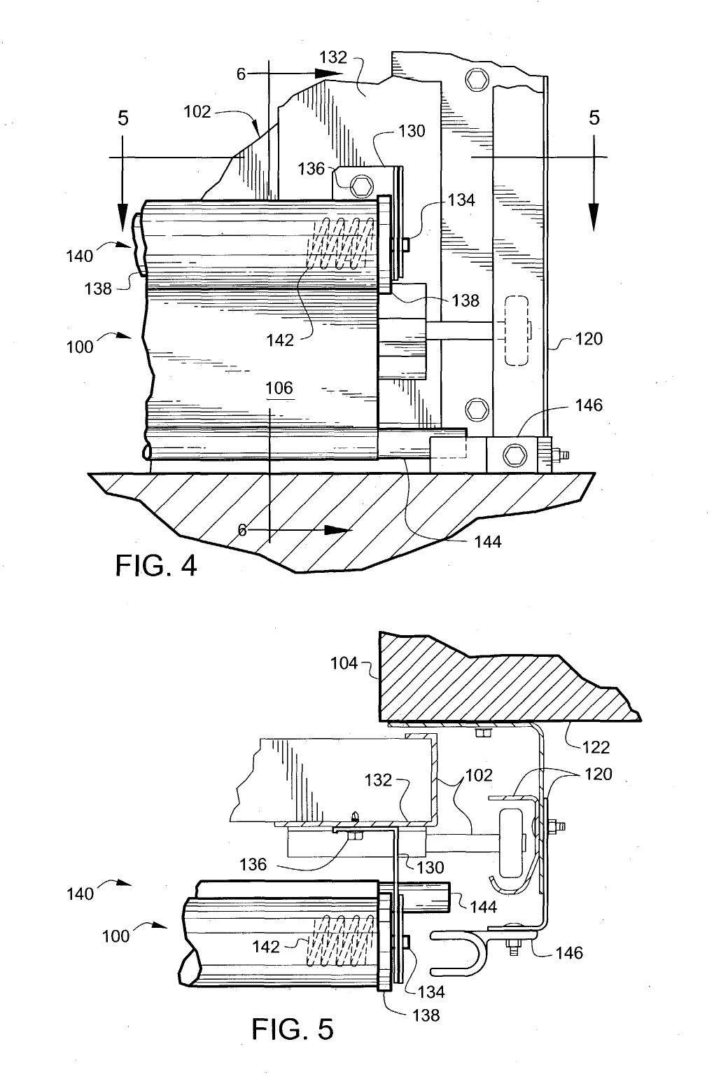

FIG. 5 is a view through the section 5-5 of FIG. 4, showing overhead door shade system 100 mounted to overhead door 102. Preferably, bottom retainer 146 (embodying herein at least one movement resister structured and arranged to resist movement of at least one portion of such at least one blocker when such at least one blocker is in an unstowed position) functions to receive and removably retain the end of hembar 144. Bottom retainer 146 is preferably designed such that hembar 144 is retained against most wind loads, but is automatically released by a strong upward movement of the hembar 144, either by the user, or by operation of the overhead door. In the preferred embodiment of FIG. 5, bottom retainer 146 comprises a “U”-shaped friction retaining socket adjustably mounted to the fixed end tracks 120 of overhead door 102, as shown. Upon reading the teachings of this specification, those with ordinary skill in the art will now understand that, under appropriate circumstances, considering such issues as user preferences, design and manufacturing requirements, marketability studies, etc., other bottom retaining arrangements such as shown in FIG. 7, FIG. 8 and FIG. 9, etc., may suffice.

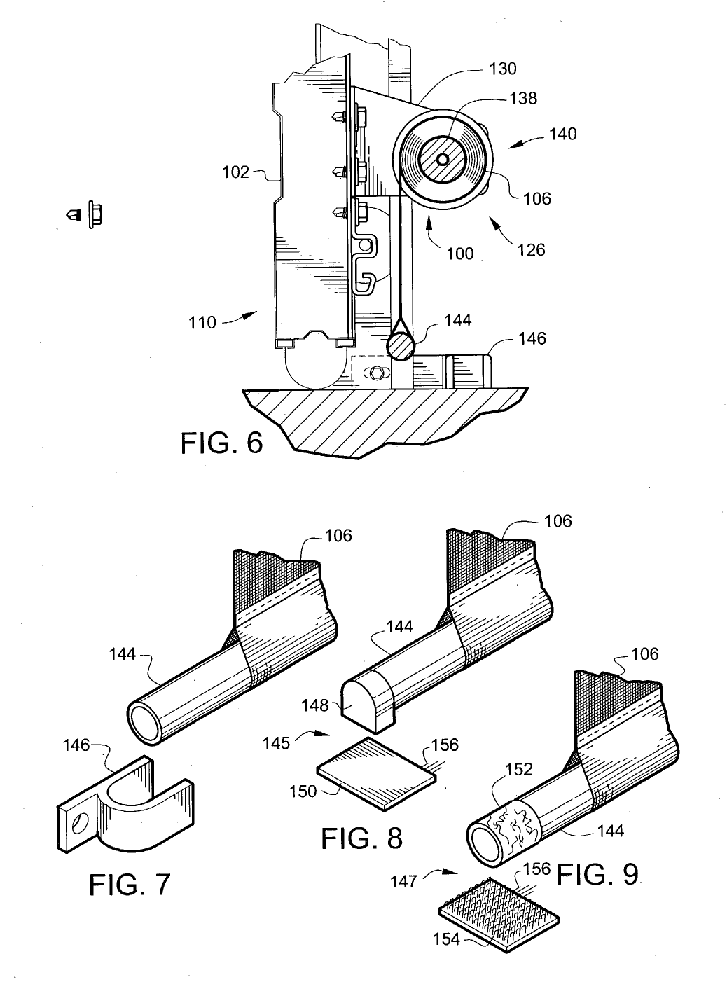

FIG. 6 is a view through the section 6-6 of FIG. 4, showing overhead door shade system 100 mounted on a closed overhead door 102. Preferably, end support bracket 130 is configured to position the moving portions of overhead door shade system 100 clear of all fixed components of overhead door 102, as shown. Illustrated in the sectional view of FIG. 6, is the interior of stored roll 126 comprising screen panel 106 wound around roller tube 138. In preferred operation, overhead door 102 is raised to an open position, allowing a user to grasp hembar 144 (or a cord attached to the hembar 144) and draw the screen panel 106 down over the door opening 110 in order to engage the bottom retainer 146. Preferably, overhead door shade system 100 is returned to a stored position by disengaging the hembar 144 from the bottom retainer 146 followed by releasing the clutch of the roller lifting system 140 in order to allow the screen panel 106 to return to a rolled position around the roller tube 138.

FIG. 7 is a partial perspective view of a preferred bottom retainer 146 (embodying herein at least one friction retainer structured and arranged to retain such at least one blocker in an essentially fixed position) of the illustrated overhead door shade system 100. Preferably, bottom retainer 146 retains hembar 144 using friction.

FIG. 8 is a perspective view, partially in section, of another preferred bottom retainer 145 of the overhead door shade system 100. Preferably, bottom retainer 145 comprises a magnetic end cap 148 attached to hembar 144, and at least one corresponding magnet-attracting-plate 150 mounted to a fixed structure, such as the floor 156, as shown. Bringing magnetic end cap 148 and corresponding magnet-attracting-plate 150 together creates a releasable bond that holds hembar 144 and screen panel 106 in an essentially fixed position (embodying herein at least one magnetic retainer structured and arranged to magnetically retain such at least one blocker in an essentially fixed position).

FIG. 9 is a perspective view, partially in section, of yet another bottom retainer 147 of the overhead door shade system 100. Preferably, bottom retainer 147 comprises an end cap 152 (preferably a hook-and-loop arrangement, as shown) attached to hembar 144 and corresponding plate 154 mounted to a fixed structure, such as the floor-156 (embodying herein at least one hook-and-loop retainer structured and arranged to retain such at least one blocker in an essentially fixed position), as shown.

FIG. 10 is a perspective view, partially in section, of an alternate preferred embodiment of the overhead door shade system 200 shown fully extended and mounted to an overhead door 102.

FIG. 10 shows overhead door shade system 200 mounted to overhead door 102, shading the interior of building structure 104. Preferably, the upper edge 158 of the overhead door shade system 200 is fastened directly to the bottom panel 124 of the overhead door 102 (without the use of a roller lifting system, as utilized by overhead door shade system 100). The preferred sizing and fabric materials of screen panel 106 are essentially identical to those of overhead door shade system 100 (as described in FIGS. 1-9). Preferably, a series of fabric grommet(s) 202 of a typical type are installed on the upper edge 158 of the screen panel 106, as shown. Each of the grommets 202 receives a fastener, such as a screw or bolt, to attach the upper edge 158 of screen panel 106 to the bottom panel 124 of the overhead door 102, as shown. Upon reading the teachings of this specification, those with ordinary skill in the art will understand that, under appropriate circumstances, considering such issues as user preference, marketability studies, ease-of-use, etc., the overhead door shade system may preferably comprise a bottom weight, such as a hembar, etc.

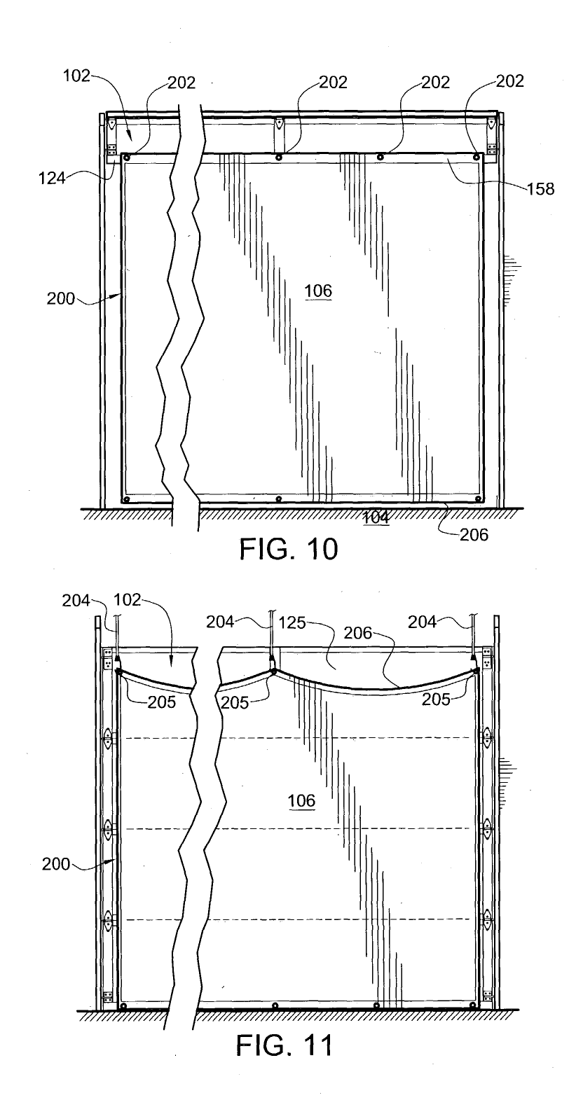

FIG. 11 is a perspective view, partially in section, of the overhead door shade system 200 of FIG. 10 shown mounted to an overhead door 102, in a stored position. Preferably, when not in use, the bottom edge 206 of screen panel 106 is secured to the upper panel 125 of overhead door 102 with a plurality of elastic cords 204 (embodying herein at least one securer structured and arranged to removably secure at least one portion of such at least one blocker to at least one interior portion of the at least one overhead-type access door, wherein such at least one securer comprises at least one elastic cord having at least one hook), as shown. Preferably, a series of fabric loops 205 (or less preferably, grommets 202) are installed along the bottom edge 206 (in this example the term bottom edge refers to the “in service” position of overhead door shade system 200) of screen panel 106 to provide attachment points for elastic cords 204, as shown. Preferably, when the attached elastic cords 204 are drawn over and fixed to upper panel 125, overhead door shade system 200 is drawn closely adjacent to the interior face 108 of overhead door 102, as shown. Upon reading the teachings of this specification, those with ordinary skill in the art will now understand that, under appropriate circumstances, considering such issues as design and manufacturing requirements, cost, availability of materials, marketability studies, etc., other fastening systems to secure the screen panel to the overhead door such as Velcro™, hooks, buttons, zippers, etc., may suffice.

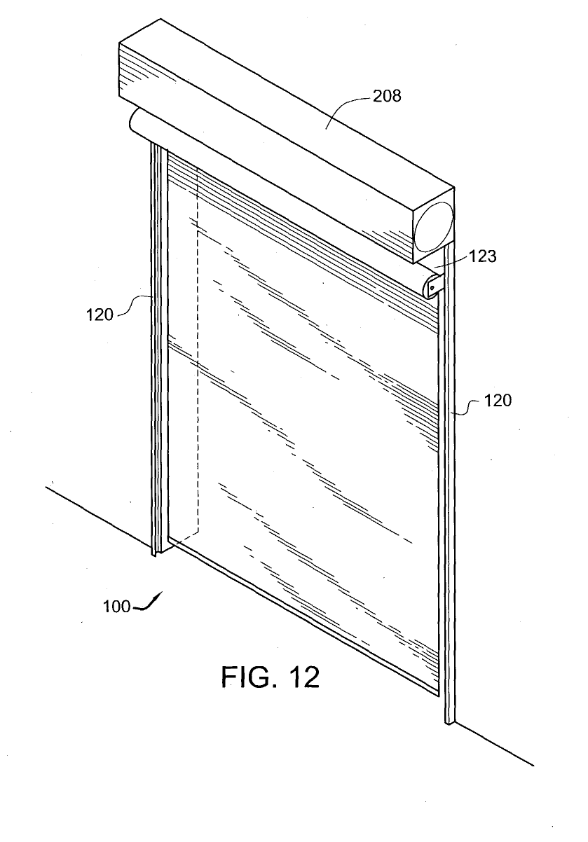

FIG. 12 is a perspective view of overhead door shade system 100 mounted to a rolling overhead door 208, according to an alternate preferred installation thereby illustrating how the overhead door shade system 100 is suitable for use with a wide range of overhead door types, including rolling and coiling-type overhead doors, as shown. Preferably, the overhead door shade system 100 mounts to the panel 123, as shown. In an alternate preferred installation, overhead door shade system 100 may mount to the end tracks 120. Upon reading the teachings of this specification, those skilled in the art will appreciate that considering the use of automatic electric drive motors with various types of transmission and linkage elements, including gear and screw drives, are well-known in the art, other raising and lowering mechanisms, such as electromechanical, hydraulic, and pneumatic mechanisms, including manual cranking mechanisms of all types (including any combination of the above-noted elements), etc., may suffice.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

What is claimed is:

1) A shading system, for shading at least one interior portion of a building from sunlight entering through at least one building opening serviced by at least one overhead-type access door, comprising in combination:
a) at least one blocker structured and arranged to block sunlight passing through at least one portion of the at least one building opening;
b) at least one attacher structured and arranged to firmly attach said at least one blocker to at least one interior portion of the at least one overhead-type access door; and
c) at least one stower structured and arranged to stow at least one portion of said at least one blocker on the interior portion of the at least one overhead-type access door when said at least one blocker is not in full use.

2) The shading system according to claim 1 wherein said at least one blocker comprises:
a) at least one flexible fabric;
b) wherein said at least one flexible fabric is structured and arranged to pass a controlled quantity of sunlight.

3) The shading system according to claim 2 wherein said at least one blocker comprises:
a) at least one tensioner structured and arranged to tension said at least one flexible fabric.

4) The shading system according to claim 3 wherein said at least one tensioner comprises:
a) at least one horizontal bottom bar.

5) The shading system according to claim 1 wherein said at least one stower comprises:
a) at least one securer structured and arranged to removably secure at least one portion of said at least one blocker to at least one interior portion of the at least one overhead-type access door.

6) The shading system according to claim 5 wherein said at least one securer comprises:
a) at least one elastic cord having at least one hook.

7) The shading system according to claim 1 wherein said at least one stower comprises:
a) at least one rolling lifter structured and arranged to lift said at least one blocker from at least one unrolled position to at least one rolled position; and
b) at least one retainer structured and arranged to retain said at least one blocker in the at least one rolled position, the at least one unrolled position and at least one intermediate rolled position.

8) The shading system according to claim 7 wherein said at least one rolling lifter comprises:
a) at least one rolling support tube; and
b) at least one spring tensioner;
c) wherein said at least one spring tensioner is structured and arranged to generate a winding force within said at least one roller tube as said at least one blocker is lowered to the unrolled position.

9) The shading system according to claim 1 wherein said at least one attacher comprises:
a) at least one support bracket mechanically fastened to the at least one overhead-type access door.

10) The shading system according to claim 1 wherein said at least one blocker comprises at least one movement resister structured and arranged to resist movement of at least one portion of said at least one blocker when said at least one blocker is in an unstowed position.

11) The shading system according to claim 10 wherein said at least one movement resister comprises at least one friction retainer structured and arranged to retain said at least one blocker in an essentially fixed position.

12) The shading system according to claim 11 wherein said at least one movement resister comprises at least one hook-and-loop retainer structured and arranged to retain said at least one blocker in an essentially fixed position.

13) The shading system according to claim 11 wherein said at least one movement resister comprises at least one magnetic retainer structured and arranged to magnetically retain said at least one blocker in an essentially fixed position.

14) The shading system according to claim 1 wherein said at least one blocker comprises at least one wind load reliever structured and arranged to relieve a wind load force acting on at least one surface portion of said at least one blocker.

15) The shading system according to claim 1 wherein said at least one blocker comprises:
a) at least one opener structured and arranged to open at least one access portal through said at least one blocker; and
b) at least one access blocker structured and arranged to block access through said at least one access portal.

16) The shading system according to claim 15 wherein said at least one access blocker comprises at least one zipper.

17) The shading system according to claim 15 wherein said at least one access blocker comprises at least one hook-and-loop fastener.

18) A shading system for shading at least one interior portion of a building from sunlight entering through at least one building opening serviced by at least one overhead-type access door, comprising in combination:
a) at least one overhead-type access door;
b) at least one blocker structured and arranged to block sunlight passing through at least one portion of the at least one building opening;
c) at least one attacher structured and arranged to firmly attach said at least one blocker to at least one interior portion of said at least one overhead-type access door; and
d) at least one stower structured and arranged to stow at least one portion of said at least one blocker on the interior portion of said at least one overhead-type access door when said at least one blocker is not in full use.

19) The shading system according to claim 18 wherein said at least one attacher comprises at least one support bracket mechanically fastened to the at least one overhead-type access door.

20) The shading system according to claim 18 wherein said at least one attacher comprises at least one support bracket integrally formed with said at least one overhead-type access door.
